(19) United States
(12) Patent Application Publication
(10) Pub. No.: US 2025/0033818 A1
(43) Pub. Date: Jan. 30, 2025

(54) AUTOMATED CONTAINER LOADER

(71) Applicant: OCADO INNOVATION LIMITED, Hatfield, Hertfordshire (GB)

(72) Inventor: Paul WESTWOOD, Hatfield, Hertfordshire (GB)

(73) Assignee: OCADO INNOVATION LIMITED, Hatfield, Hertfordshire (GB)

(21) Appl. No.: 18/712,982

(22) PCT Filed: Nov. 28, 2022
(86) PCT No.: PCT/EP2022/083540

§ 371 Date: May 23, 2024

(30) Foreign Application Priority Data
Nov. 29, 2021 (GB) 2117215.0

(51) Int. Cl. B65B 43/59; B65B 5/06; B65G 61/00; B65G 65/00; B65G 69/16

(52) U.S. Cl. CPC B65B 43/59; B65B 5/06; B65G 61/00; B65G 65/005; B65G 69/16; B65G 2203/025

(57) ABSTRACT

An automated container loader for loading a smaller storage container into a larger storage container. The loader includes a container support for receiving a larger storage container and a container loading assembly configured to receive a smaller storage container above the larger storage container and release the smaller storage container to allow the smaller storage container to descend under gravity into the larger storage container. The container loading assembly also includes a plurality of engagement surfaces configured to engage the smaller storage container during at least a portion of the descent of the smaller storage container to control the descent velocity of the smaller storage container under gravity.

### TECHNICAL FIELD

The present invention relates to an automated apparatus for loading a smaller storage container into a larger storage container in a storage and retrieval system.

### BACKGROUND

Some commercial and industrial activities require systems that enable the storage and retrieval of a large number of different products. WO2015019055A1 describes a storage and retrieval system in which stacks of storage containers are arranged within a grid storage structure. The storage containers are accessed from above by load handling devices operative on rails or tracks located on the top of the grid storage structure.

Before entering the grid storage structure, the storage containers are loaded with items for storage. For some products (particularly fresh products and chilled products), the items may be delivered by the supplier in crates, e.g. reusable plastic crates/containers (RPCs) such as those manufactured and supplied by IFCO Systems GmbH. To avoid the time and space costs of transferring items from the RPCs to the storage containers and storing the empty RPCs until they can be returned to the supplier, an RPC and its items can be directly loaded into a storage container. The combined RPC and storage container can then be stored in the storage structure.

RPCs are typically loaded into storage containers by hand. In order to improve efficiency, it is desirable to automate the loading process. However, there are a number of challenges to overcome to allow the loading process to be automated reliably and efficiently.

These challenges include the following:
The RPC needs to be loaded into the storage container without damaging the items inside the RPC.
The size, weight and centre of gravity of each RPC may vary depending on the items in the RPC and the distribution of items within the RPC. An automated system would ideally accommodate different variations of these variables such that each RPC is loaded in a stable and reliable manner.
The dimensions of the RPC and the storage container may be similar such that there is only a small gap (e.g. a few millimetres) between the sidewalls of the RPC and the storage container. This limits the space available for a container handling mechanism.
The size of the opening or cavity of the storage containers may not be consistent, even between storage containers that were originally manufactured to be the same size. This is because the sidewalls of the storage containers can become warped (e.g. bow inwards) over time. Warped sidewalls may decrease the size of the opening or cavity of the storage container enough such that the sidewalls impede the insertion of the RPC into the storage container.
The external features (e.g. protrusions, recesses, apertures, etc.) of RPCs vary depending on the manufacturer and the product line. An automated system would ideally handle RPCs with different external features in a reliable and reproducible manner.

There is therefore a need for an apparatus that can automate the loading of a smaller container (such as an RPC) into a larger storage container in an efficient, reliable and reproducible manner, while minimising the risk of damaging the items within the smaller container.

### SUMMARY OF INVENTION

The invention is defined in the accompanying claims.

### Automated Container Loader

An automated container loader for loading a smaller storage container into a larger storage container is provided. The automated container loader comprises:
a container support for receiving a larger storage container; and
a container loading assembly configured to receive a smaller storage container above the larger storage container and release the smaller storage container to allow the smaller storage container to descend under gravity into the larger storage container;
wherein the container loading assembly comprises a plurality of engagement surfaces configured to engage the smaller storage container during at least a portion of the descent of the smaller storage container to control the descent velocity of the smaller storage container under gravity.

By providing engagement surfaces that engage the smaller storage container during its descent into the larger storage container, the descent velocity of the smaller storage container can be reduced, thereby reducing the impact force between the smaller storage container and the larger storage container at the end of the smaller storage container's descent. This is particularly useful in situations where the smaller storage container holds fragile goods that may break if the impact force between the smaller storage container and the larger storage container is too high.

The container loading assembly may comprise a trapdoor comprising at least two door panels. Each door panel may define one of the plurality of engagement surfaces. Each door panel may be pivotally mounted for rotation about a respective horizontal pivot axis. The door panels may be pivotally rotatable downwards from a substantially horizontal initial position for receiving the smaller storage container above the larger storage container, towards a final position to allow the smaller storage container to descend between the pivot axes into the larger storage container under gravity. The container loading assembly may further comprise a control system comprising a controller configured to control pivotal rotation of the door panels between the initial position and the final position such that the door panels frictionally engage the smaller storage container during at least a portion of the descent of the smaller storage container to control the descent velocity of the smaller storage container under gravity.

The trapdoor may have two door panels with their respective pivot axes arranged parallel to each other and lying in the same horizontal plane. The pivots axes may be spaced apart such that the door panels can rotate past each other without colliding. Each pivot axis may be defined by the longitudinal axis of a rotatable shaft. Each door panel may be rigidly mounted to a respective rotatable shaft.

The controller may be configured to control pivotal rotation of the door panels such that the door panels frictionally engage (via sliding contact) respective sidewalls of the smaller storage container during said portion of the descent of the smaller storage container.

The door panels may be stoppable at at least one intermediate angular position between the initial position and the final position. The door panels may be stoppable at any one of a plurality of intermediate angular positions between the initial position and the final position. The door panels may be pivotally rotatable upwards from one of the plurality of intermediate angular positions to another one of the plurality of intermediate angular positions. In this way, the angular position of the door panels can be finely adjusted during the descent of the smaller storage container to increase or decrease the frictional engagement between the door panels and the smaller storage container which will decrease or increase the descent velocity of the smaller storage container respectively.

The controller may use closed-loop control during said portion of the descent of the smaller storage container. The control system may further comprise at least one displacement sensor configured to measure the vertical displacement of the smaller storage container during said portion of the descent of the smaller storage container. The displacement sensor may be located above the trapdoor. The controller may be configured to control the angular position of the door panels based on the displacement measurements from the at least one displacement sensor.

For example, the controller may be configured to determine the descent velocity and/or acceleration of the smaller storage container based on measurements from the at least one displacement sensor. The controller may be configured to control the angular position of the door panels to keep the descent velocity and/or acceleration of the smaller storage container below a maximum velocity and/or acceleration threshold. The maximum descent acceleration threshold may be the acceleration due to gravity, approximately 9.8 m/s².

The controller may be configured to pivotally rotate the door panels upwards when the descent velocity of the smaller storage container exceeds the predetermined maximum velocity and/or acceleration threshold. By rotating the door panels upwards, the frictional engagement between the door panels and the smaller storage container can be increased, thereby reducing the descent velocity and/or acceleration below the maximum velocity and/or acceleration threshold.

The controller may be further configured to pivotally rotate the door panels downwards when the descent velocity and/or acceleration of the smaller storage container falls below a minimum velocity and/or acceleration threshold. By rotating the door panels downwards, the frictional engagement between the door panels and the smaller storage container can be decreased, thereby increasing the descent velocity and/or acceleration above the minimum velocity and/or acceleration threshold.

The control system may comprise a plurality of displacement sensors configured to measure the vertical displacement of different portions of the smaller storage container during descent of the smaller storage container. The plurality of displacement sensors may be located above the trapdoor. The plurality of displacement sensors may be arranged above the trapdoor to measure the vertical displacement of each corner of the smaller storage container, for example. The controller may be configured to determine the orientation of the smaller storage container relative to a horizontal plane based on the measurements from the plurality of displacement sensors. The controller may be configured to halt pivotal rotation of the door panels if the controller determines that the smaller storage container has titled away from the horizontal plane by a predetermined extent.

The control system may comprise a plurality of displacement sensors configured to measure the vertical displacement of different portions of the smaller storage container during descent of the smaller storage container. The plurality of displacement sensors may be located above the trapdoor. The plurality of displacement sensors may be arranged above the trapdoor to measure the vertical displacement of each corner of the smaller storage container, for example. The controller may be configured to determine the orientation of the smaller storage container relative to a horizontal plane based on the measurements from the plurality of displacement sensors. The controller may be configured to control the angular position each door panel to keep the orientation of the smaller storage container substantially horizontal during the descent of the smaller storage container.

The controller may use open-loop control during said portion of the descent of the smaller storage container. The controller may be configured to pivotally rotate the door panels between the initial position and the final position according to a predetermined motion profile. The predetermined motion profile may be chosen such that the door panels are rotated downwards at a rate such that the door panels frictionally engage the smaller storage container during said portion of the descent of the smaller storage container.

The controller may be configured to control pivotal rotation of the door panels to stop the descent of the smaller storage container at an intermediate descent position above a final descent position. The container loading assembly may further comprise a pushing device configured to push the smaller storage container downwards from the intermediate descent position to the final descent position at a predetermined rate.

The door panels may be elastically deflectable. In other words, the door panels may deflect when under load from the smaller storage container (particularly when the door panels are frictionally engaging the sidewalls of the smaller storage container) and return to their pre-deflected state when the load is removed. This may increase the surface area contact between the door panels and the smaller storage container, which may result in more reliable frictional engagement between the door panels and the smaller storage container and also spread wear on the door panels over a greater surface area.

Each door panel may be split along a direction perpendicular to the pivot axis to define a first door panel portion and a second door panel portion. The first and second door panel portions may be pivotally rotatable in unison about the pivot axis of their respective door panel. The first door panel portion and the second door panel portion may be independently elastically deflectable. Such a split door panel arrangement may be used to load a first smaller storage container and a second smaller storage container having different sizes and/or weights into the larger storage container side-by-side. The controller may be configured to the angular position of the door panels according to the smaller storage container that is descending the fastest. Alternatively, each door panel portion may be independently pivotally rotatable about the pivot axis of their respective door panels to independently control the descent velocity of the first and second smaller storage containers.

Each door panel may comprise a mounted end at which the door panel is pivotally mounted, and a free end opposing the mounted end. Each free end may have a castellated shape. The door panels may be arranged such that the castellations of the free ends interdigitate when the door panels are in the horizontal initial position. In this way, the width (distance between the mounted and free ends) of each door panel may be extended further than would otherwise be possible without the interdigitated castellations, which allows each door panel to remain in frictional engagement with the smaller storage container for a greater distance during the descent of the smaller storage container.

The door panels may be configured to pivotally rotate in unison. The container loading assembly may comprise a single actuator configured to pivotally rotate the door panels in unison. The actuator may be controlled by the controller to control the angular position of the door panels. For example, the door panels may be mechanically linked to a common guided carriage arranged to move up and down along a vertical guide. The guided carriage may be driven by the actuator along the vertical guide such that the door panels to be pivotally rotated upwards or downwards in unison.

The door panels may be pivotally rotatable independently of each other. The controller may be configured to control the angular position of the door panels independently of each other. For example, each door panel may be pivotally rotated by a separate actuator.

The container loading assembly may further comprise guide members above the trapdoor. The guide members may be configured to engage respective sidewalls of the smaller storage container to guide the smaller storage container to a symmetrical position on the door panels. Alternatively or additionally, the guide members may engage respective sidewalls of the smaller storage container to help maintain the smaller storage container in a vertical orientation during at least a portion of the descent of the smaller storage container into the larger storage container.

The container support and the trapdoor may be vertically moveable relative to each other to allow the larger storage container and the door panels to be moved into a relative position in which pivotal rotation of the door panels from the initial position to the final position causes the door panels to rotate into the larger storage container. The container support may be vertically moveable relative to the trapdoor, or the trapdoor may be vertically moveable relative to the container support. This minimises or eliminates the amount of time the smaller storage container is in free fall before it reaches the base of the larger storage container, which helps to reduce the impact force between the smaller storage container and the larger storage container. Furthermore, if any of the sidewalls of the larger storage container bow inwards (due to wear etc.), the pivotal rotational movement of the door panels against the sidewalls of the larger storage container can be used to force the bowed sidewalls outwards, thereby allowing the smaller storage container to descend more easily.

### Method

A method for loading a smaller storage container into a larger storage container in an automated manner is provided. The method comprises the steps of:
receiving a smaller storage container on a trapdoor above a larger storage container, the trapdoor comprising at least two pivotally mounted door panels in a horizontal initial position for receiving the smaller storage container;
pivotally rotating the door panels downwards to allow the smaller storage to descend between the door panels into the larger storage container under gravity;
controlling pivotal rotation of the door panels during the descent of the smaller storage container such that the door panels frictionally engage the smaller storage container during at least a portion of the descent.

Pivotal rotation of the door panels may be controlled such that the door panels frictionally engage respective sidewalls of the smaller storage container during said portion of the descent.

Pivotal rotation of the door panels may be controlled such that the door panels are in contact with the smaller storage container throughout the whole descent of the smaller storage container into the larger storage container.

The method may further comprise the steps of:
measuring the vertical displacement of the smaller storage container during the descent of the smaller storage container into the larger storage container;
calculating the descent velocity and/or acceleration of the smaller storage container based on the vertical displacement measurements;
controlling the angular position of the door panels during the descent of the smaller storage container to keep the descent velocity and/or acceleration of the smaller storage container below a maximum velocity threshold.

### BRIEF DESCRIPTION OF THE DRAWINGS

The present invention will now be described, by way of example only, with reference to the accompanying drawings, in which like reference numerals are used for like features, and in which:

FIG. 1 is a perspective view of an automated container loader showing a smaller storage container and a larger storage container approaching a container loading assembly and a container support respectively.

FIG. 2 is a perspective view of the container loading assembly shown in FIG. 1.

FIG. 3 is a perspective view of the automated container loader of FIG. 1 showing the smaller storage container on the container loading apparatus and the larger storage container on the container support.

FIG. 4 is a perspective view of the automated container loader in a state following on from FIG. 3 in which the container support has raised the larger storage container towards the container loading assembly.

FIG. 5 is a perspective view of the automated container loader in a state following on from FIG. 4 in which the container loading assembly has dropped the smaller storage container into the larger storage container.

FIG. 6 is a perspective view of the automated container loader in a state following on from FIG. 5 in which the container support has lowered the loaded larger storage container away from the container loading assembly.

FIG. 7 is a perspective view of the automated container loader in a state following on from FIG. 6 in which the loaded larger storage container is leaving the automated container loader.

FIGS. 8A-8E are a sequence of side cross-sectional views of the automated container loader of FIG. 1, showing the descent of a smaller storage container into a larger storage container using the container loading assembly.

FIG. 9A is a graph showing the angular position of a door panel of the container loading assembly with respect to time as a smaller storage container is being loaded into a larger storage container.

FIG. 9B is a graph showing the vertical displacement of the smaller storage container vs time as the smaller storage container is being loaded into the larger storage container using the container loading assembly.

FIG. 10 is a schematic block diagram of a control system for controlling doors panels of the container loading assembly.

FIG. 11 is a perspective view of a container loading assembly comprising a pushing device.

FIG. 12 is a perspective view of a container loading assembly which has received two smaller storage containers arranged side-by-side.

FIG. 13 is a perspective view of a trapdoor in which each of the door panels of the trapdoor has been split into two portions.

FIG. 14 shows top views comparing a trapdoor in which the door panels of the trapdoor comprise interdigitating castellations and a trapdoor without the castellations.

FIG. 15 shows side cross-sectional views comparing the castellated and non-castellated trapdoors of FIG. 14 when in a vertical position extending into a storage container.

FIG. 16 is a perspective view of a grid storage structure.

### DETAILED DESCRIPTION

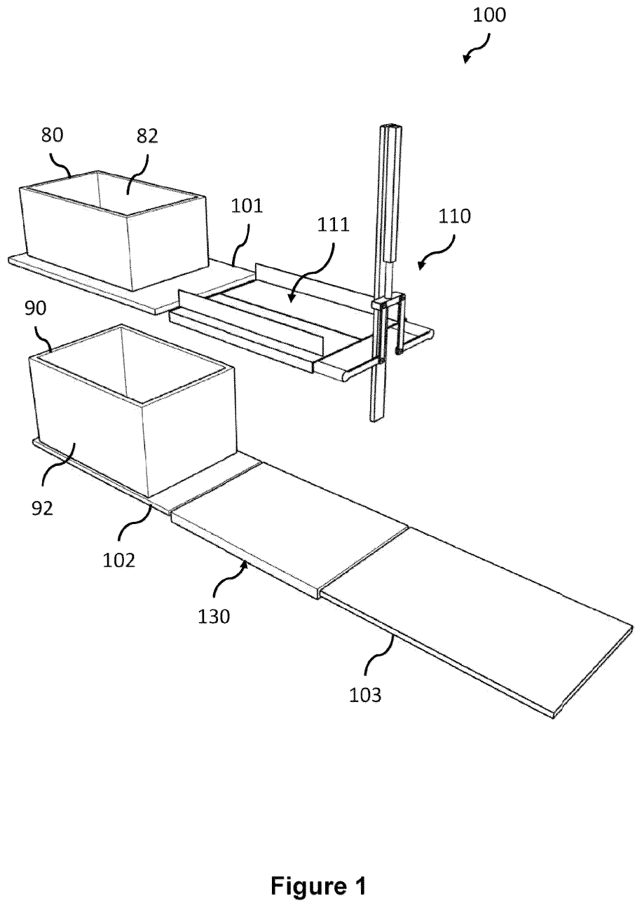

FIG. 1 shows an automated container loader 100 for loading a smaller storage container 80 into a larger storage container 90. The automated container loader 100 may be part of a storage and retrieval system in which larger storage containers 90 are used to store items for later retrieval. As described in the above background section, the smaller storage container 80 being loaded by the automated container loader 100 may be in the form of reusable plastic containers (RPCs), such as those manufactured and supplied by IFCO Systems GmbH. The purpose of the automated container loader 100 is to load one or more smaller storage containers 80 directly loaded into a larger storage container 90 before the larger storage container 90 is transported to a storage area of the storage and retrieval system.

The smaller storage container 80 and larger storage container 90 both have a rectangular base with four sidewalls 82, 92 extending from the base to define an opening at the top. The smaller storage container 80 has smaller horizontal dimensions than the larger storage container 90 such that the smaller storage container 80 can be placed into and contained in the larger storage container 90 through the top opening of the larger storage container 90. Either or both of the smaller and larger storage containers 80, 90 may be collapsible, e.g. one or more sidewalls 82, 92 may be foldable relative to the base.

The automated container loader 100 comprises a container loading assembly 110 configured to receive a smaller storage container 80. The smaller storage container 80 arrives at the container loading assembly 110 via a conveyor unit 101, but could also arrive via other automated or manual transporting means. The container loading assembly 110 and the conveyor unit 101 may be mounted on a frame (not shown for clarity).

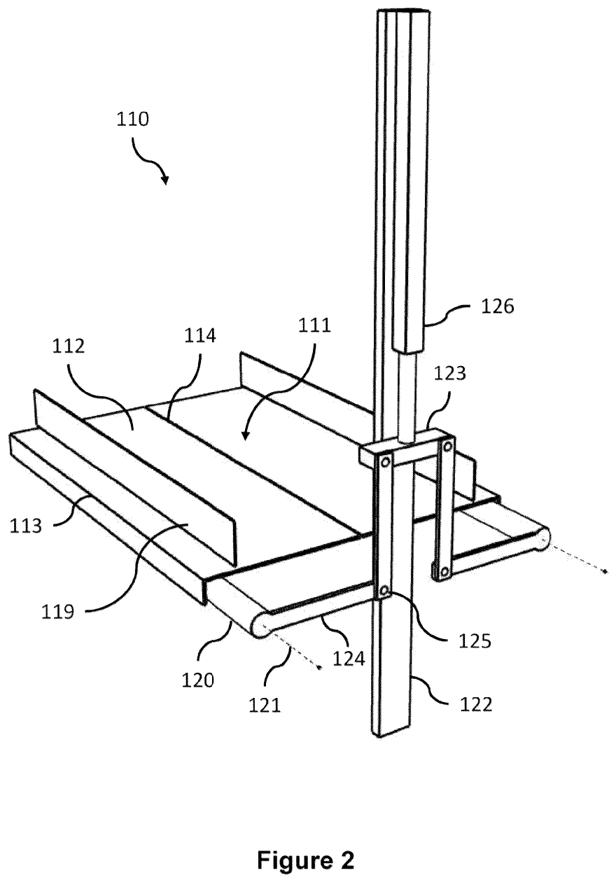

The container loading assembly is shown in isolation in FIG. 2. The container loading assembly 110 comprises a trapdoor 111. The trapdoor 111 comprises two rectangular door panels 112, each having a mounted end 113 and a free end 114 opposing the mounted end 113. The mounted end 113 of each door panel 112 is rigidly mounted to a respective horizontal shaft 120 that is rotatable about its longitudinal axis 121. Therefore, each door panel 112 is rotatable about a horizontal pivot axis 121 corresponding to the longitudinal axis 121 of its respective shaft 120. The shafts 120 are arranged parallel to each other and lie in the same horizontal plane. The shafts 120 are also spaced apart such that the free ends 114 of the door panels are able to rotate past each other without colliding.

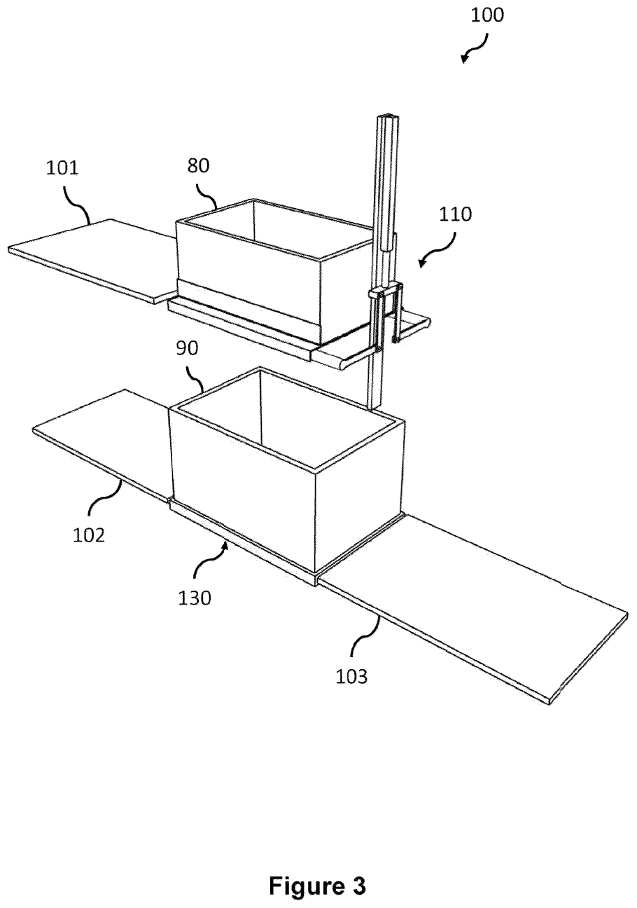

FIGS. 1 and 2 show the trapdoor 111 in a closed configuration in which the door panels are in a horizontal initial position with the free ends 114 pointing towards each other. Together, the door panels form a substantially horizontal upward-facing surface for receiving the smaller storage container 80. FIG. 3 shows the smaller storage container 80 received on the upward-facing surface of the trapdoor 111. The upward-facing surface does not need to be contiguous, as there may be a gap between the free ends 114 of the door panels when the trapdoor 111 is in the closed configuration. The width (defined as the distance between the mounted end 113 and the free end 114) of the door panels 112 are substantially the same such that the door panels are symmetrically arranged about a centreline running parallel between the two pivot axes 121.

To open the trapdoor 111, the door panels are pivotally rotated downwards from the horizontal position towards a vertical final position. This creates an increasingly widening opening below the smaller storage container 80 that allows the smaller storage container 80 to descend through the trapdoor 111, between the shafts 120.

Both of the door panels are mechanically linked via linkage arms 124 and joints 125 to a common guided carriage 123 centrally positioned with respect to the pivot axes 121 at one end of the trapdoor 111. The guided carriage 123 is arranged to move up and down along a vertical guide 122. The linkage arms 124 and joints 125 are configured such that when the guided carriage 123 moves up the vertical guide 122, the door panels pivotally rotate upwards in unison and when the guided carriage 123 moves down the vertical guide 122, the door panels pivotally rotate downwards in unison. The vertical position of the guided carriage 123 along the vertical guide 122 is controlled by an electric linear actuator 126, such as a lead screw actuator. The linear actuator 126 allows the guided carriage 123 to move to and stop at any one of a plurality of positions along the vertical guide 122 such that the door panels can be pivotally rotated to and stop at any one of a plurality of intermediate angular positions between the initial and final positions.

The container loading assembly 110 further comprises side guides 119 located above the door panels. The side guides 119 are in the form of two vertical panels opposing each other in the horizontal direction and aligned parallel to the direction in which the smaller storage container 80 moves onto the trapdoor 111. One purpose of the side guides 119 is to help centre the smaller storage container 80 on the closed trapdoor 111 such that the smaller storage container 80 is symmetrically disposed on the door panels. Another purpose of the side guides 119 is to help to maintain the smaller storage container 80 in a vertical orientation as the smaller storage container 80 descends into the larger storage container 90 (i.e. the side guides 119 help to prevent the smaller storage container 80 from tilting to one side during descent). In one example, the side guides 119 may be configured to move towards each other once the smaller storage container 80 has been received on the trapdoor 111 such that the position of the smaller storage container 80 is adjusted by the side guides 119 towards a central position on the trapdoor 111. This would also allow the container loading assembly 110 to be used for smaller storage containers 80 of different widths. In another example, the side guides 119 may be symmetrically fixed about a centre-line of the trapdoor 111, and each side guide 119 may comprise a tapered portion to form a tapered opening for guiding the smaller storage container 80 to the correct position between the side guides 119 as the smaller storage container 80 is moved onto the trapdoor 111.

The smaller storage container 80 can be transferred from the conveyor unit 101 to the trapdoor 111 using any suitable transferring mechanism. For example, the automated container loader 100 may comprise a pushing member that horizontally pushes the smaller storage container 80 from the conveyor unit 101 onto the trapdoor 111, or a gripping device that grips the smaller storage container 80 on the conveyor unit 101, horizontally moves the smaller storage container 80 onto the trapdoor 111 and then releases it.

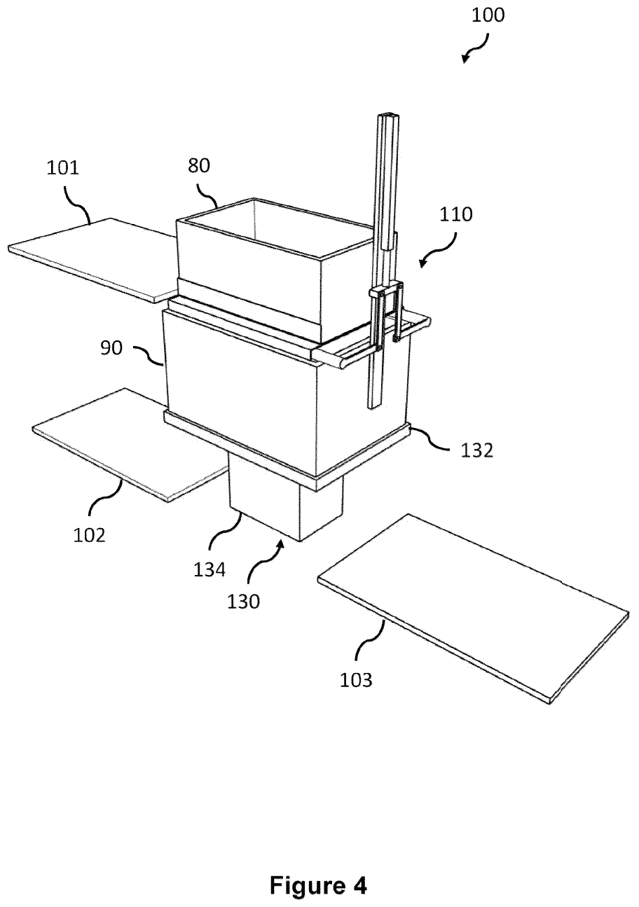

The automated container loader 100 further comprises a container support 130 for receiving a larger storage container 90 directly below the trapdoor 111 of the container dropping assembly, as shown in FIG. 3. The larger storage container 90 arrives at the container support 130 via a conveyor unit 102 or other transporting means. The container support 130 comprises a platform 132 for receiving the larger storage container 90. Similar to the container loading assembly 110, the container support 130 may comprise side guides or other locating means for locating the larger storage container into a particular position on the platform 132. The platform 132 may be in the form of another conveyor unit to facilitate movement of the larger storage container 90 on and off the platform 132, or a transferring mechanism similar to the transferring mechanism described above (in relation to conveyor unit 101 and the trapdoor 111) may be provided to transfer the larger storage container 90 on and off the platform 132. As shown in FIG. 4, the container support 130 further comprises a lifting mechanism 134 configured to raise and lower the platform 132 to vertically move the larger storage container 90 towards and away from the trapdoor 111 respectively. In particular, the lifting mechanism 134 is configured to vertically move the larger storage container 90 between a lower release position (the position shown in FIG. 3) and a raised loading position (the position shown in FIG. 4).

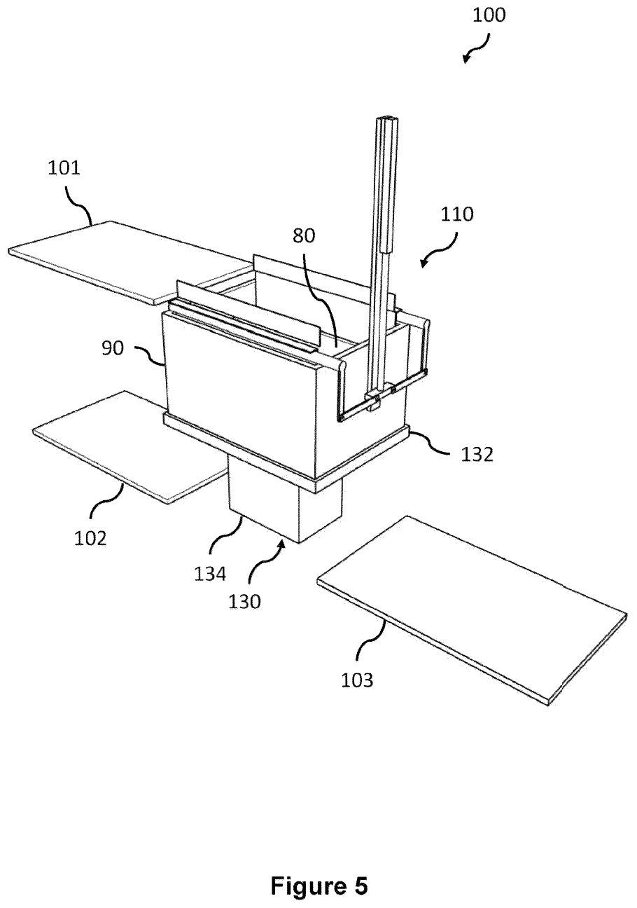

FIG. 5 shows the larger storage container 90 in the raised loading position with the trapdoor 111 open. In the raised loading position, the larger storage container 90 is vertically positioned with respect to the trapdoor 111 such that the trapdoor 111 opens into the larger storage container 90, i.e. at least a portion of each door panel 112 enters the cavity (defined by the base and sidewalls 92) of the larger storage container 90 as the door panels are pivotally rotated downwards from the horizontal position. The loading position is used when the smaller storage container 80 is being loaded into the larger storage container 90. This has the following advantages. First, the descent of the smaller storage container 80 can be controlled by the door panels while the smaller storage container 80 is within the larger storage container 90. This minimises or eliminates the amount of time the smaller storage container 80 is in free fall before it reaches the base of the larger storage container 90, which helps to reduce the impact force between the smaller storage container 80 and the larger storage container 90. Second, the sidewalls 92 of the larger storage container 90 will generally be substantially vertical when first manufactured, but through continued use, one or more sidewalls may end up bowing inwards due to wear. Inwardly bowing sidewalls may decrease the inner dimensions of the larger storage container 90 such that the smaller storage container 80 is obstructed from fully entering the larger storage container 90 unless a downwards force is exerted on the smaller storage container 80. By having the trapdoor 111 open into the larger storage container 90, the door panels may force any inwardly bowing sidewalls outwards such that the smaller storage container 80 can enter the larger storage container 90 under gravity without needing to be pushed.

When the larger storage container 90 is in the loading position with the trapdoor 111 open and the smaller storage container 80 fully loaded into the larger storage container 90, the door panels are located in the space between the sidewalls 82 of the smaller storage container 80 and the sidewalls 92 of the larger storage container 90. This arrangement blocks the loaded larger storage container 90 from leaving the automated container loader 100 in a horizontal direction and blocks the trapdoor 111 from closing to receive the next smaller storage container 80. Therefore, after the larger storage container 90 has been loaded with the smaller storage container 80, the larger storage container 90 is lowered to the release position.

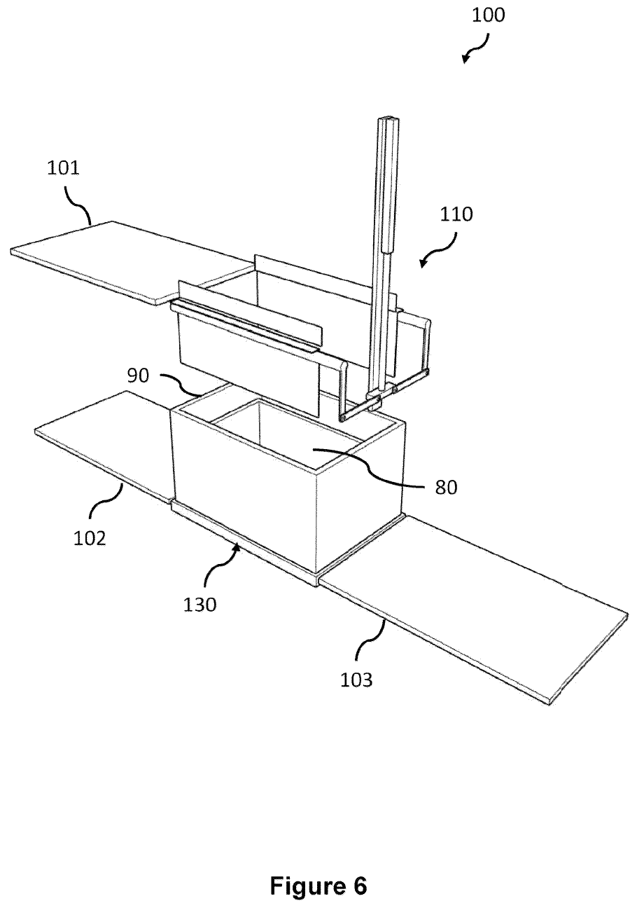

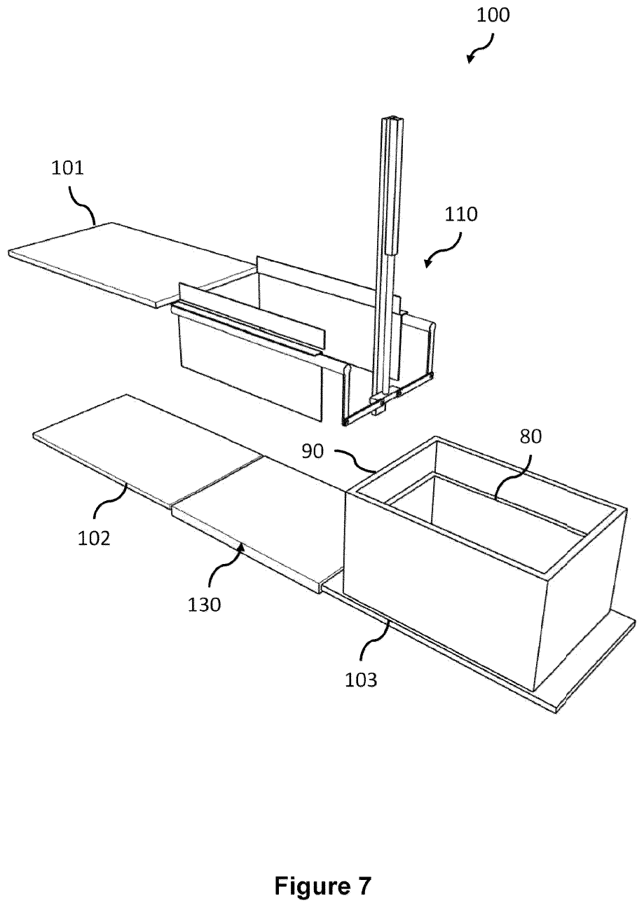

FIG. 6 shows the loaded larger storage container 90 in the lower release position with the trapdoor 111 open. In the lower release position, the larger storage container 90 is vertically clear of the door panels, which allows the loaded larger storage container 90 to be transported off the container support 130 and away from the automated container loader 100 via conveyor unit 103 or other transporting means without obstruction from the door panels. FIG. 7 shows the loaded larger storage container 90 on conveyor unit 103 after leaving the container support 130. The release position also allows the door panels to rotate back to the horizontal position to repeat the loading process with a new set of smaller and larger storage containers 80, 90.

Referring back to FIG. 3, it can be seen that the container support 130 is in the release position when receiving the empty larger storage container 90 from conveyor unit 102. However, either the loading position or the release position may be used to receive the empty larger storage container 90 (with an appropriate adjustment to the position of conveyor unit 102), with the container support 130 moving to the other position as necessary during operation.

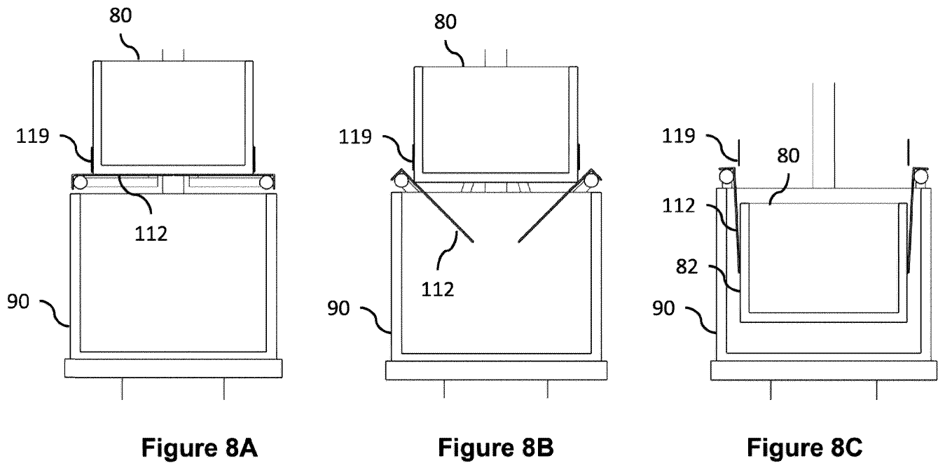

FIGS. 8A-8E are a sequence of cross-sectional views of the automated container loader 100 along a cutting plane extending perpendicularly through the pivot axes 121 of the door panels 112, facing towards the vertical guide 122. FIGS. 8A-8E show the relative positions of the smaller storage container 80, the door panels and larger storage container 90 at various stages during the process of loading the smaller storage container 80 into the larger storage container 90.

FIG. 8A shows the trapdoor 111 closed with the door panels 112 in the horizontal position. The smaller storage container 80 is symmetrically positioned on top of the door panels such that the smaller storage container 80 straddles the centre-line between the two pivot axes 121 and is supported from below by both door panels 112. The larger storage container 90 is sitting on the container support platform 132 and is in the loading position directly below the trapdoor 111.

In FIG. 8B, the door panels 112 have started to pivotally rotate downwards such that the trapdoor 111 is partially open. At this point, vertical displacement of the smaller storage container 80 is negligible because the bottom edges of the smaller storage container 80 are still supported by portions of the door panels 112 close to the pivot axes 121.

In FIG. 8C the door panels 112 have rotated further downwards from the position in FIG. 8B. At this point, the opening between the door panels 112 is wide enough such that the smaller storage container 80 is no longer supported from below by the door panels 112. However, the opening between the door panels 112 is still slightly narrower than the width of the smaller storage container 80 such that the “upward”-facing surfaces of the door panels 112 (which previously received the smaller storage container 80 when the door panels 112 were in the horizontal position) frictionally engage with (i.e. slide against) the outer surface of respective sidewalls 82 on opposing sides of the smaller storage container 80. The frictional force between the door panels and the sidewalls 82 of the smaller storage container 80 opposes the gravitational force acting on the smaller storage container 80 so as to slow the descent of the smaller storage container 80 under gravity into the larger storage container 90.

In FIG. 8D, the smaller storage container 80 has finished its descent by making contact with the base of the larger storage container 90. The smaller storage container 80 has now been loaded into the larger storage container 90. At this point, the door panels 112 are still in contact with the smaller storage container 80.

In FIG. 8E, the door panels 112 have rotated to a vertical position (90 degrees downward from the horizontal position). In this position, the door panels 112 are disengaged from the sidewalls 82 of the smaller storage container 80 so that the loaded larger storage container 90 can be lowered to the release position without the door panels 112 potentially pulling the smaller storage container away from the larger storage container.

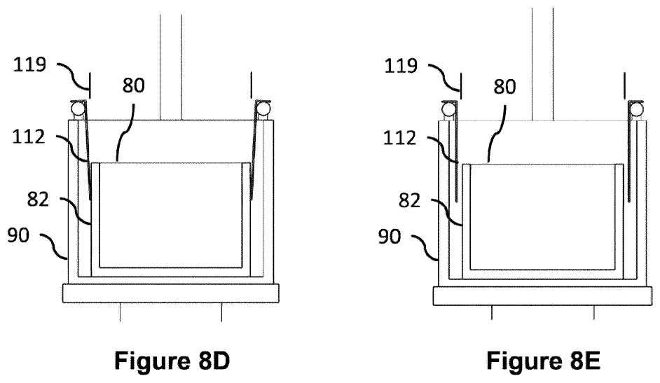

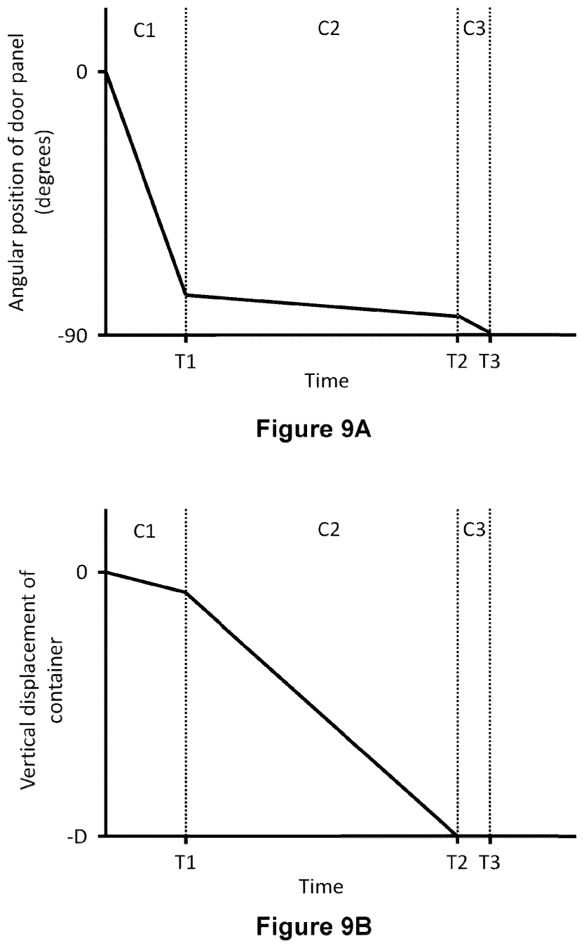

FIG. 9A is a graph showing an example of how the angular position (θ) of one of the door panels 112 changes over time (t). In this example, the door panels 112 rotate in unison and therefore a graph of the angular position of the other door panel 112 over time would look similar. The graph shows the door panel 112 starting from the horizontal position (θ=0 at t=0) and ending at the vertical position (θ=−90° at t=T). FIG. 9B is a graph showing how the vertical displacement (x) of smaller storage container 80 varies over the same time period as the graph of FIG. 9A, starting from a position on top of the closed trapdoor 111 (x=0 at t=0) and ending with the smaller storage container 80 at the bottom of the larger storage container 90 (x=−D at t=T).

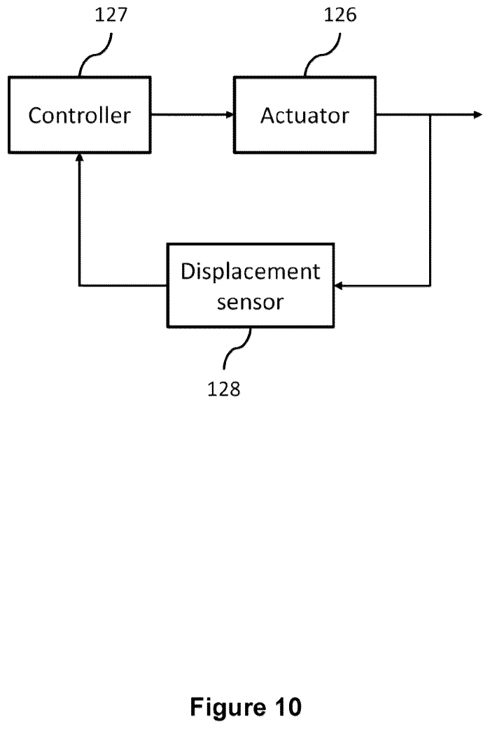

FIG. 10 shows a block diagram of an example control system for controlling the angular position of the door panels 112 during at least part of the above-described sequence. The control system comprises a controller 127 and a displacement sensor 128 located above the trapdoor 111 for measuring the vertical displacement of the smaller storage container 80 as it descends into the larger storage container 90. The displacement sensor 128 may be any suitable type of displacement sensor, e.g. an optical, ultrasonic, or laser displacement sensor. The controller 127 controls the linear actuator 126 in response to measurements from the displacement sensor 128 to control the angular position of the door panels 112.

The controller 127 controls the linear actuator 126 in accordance with three control regimes, C1, C2 and C3 which operate at different time periods, as indicated on FIGS. 9A and 9B. The first control regime C1 (hereinafter referred to as the “supported” control regime) operates in the time period up to time T1 in which the bottom of the smaller storage container 80 is still supported from below by the door panels 112 (e.g. as shown in FIG. 8B). The second control regime C2 (hereinafter referred to as the “frictional” control regime”) operates in the time period between T1 and T2 in which the door panels 112 are no longer supporting the smaller storage container 80 from below and are now frictionally engaging the sidewalls 82 of the smaller storage container 80 (e.g. as shown in FIG. 8C). The third control regime C3 (hereinafter referred to as the “release” control regime”) operates in the time period between T2 and T3 to disengage the door panels 112 from the smaller storage container 80 after the smaller storage container 80 has been fully received in the larger storage container 90 (e.g. as shown in FIG. 8E).

During the supported control regime C1, the vertical displacement of the smaller storage container 80 will generally be small or negligible, particularly if the distance between the pivot axes 121 of the door panels 112 is similar to the width of the smaller storage container 80. This is because the portions of the door panels 112 supporting the bottom edges of the smaller storage container 80 are close to the pivot axes 121 and therefore the supporting portions do not undergo a large vertical displacement as the door panels 112 rotate downwards from the horizontal position. The supported control regime can be open-loop as the door panels 112 can be rotated downwards at a predetermined rate until the frictional control regime begins.

During the frictional control regime C2, the smaller storage container 80 is vertically sliding between the door panels 112 under gravity and therefore the rate of descent of the smaller storage container 80 depends on the weight of the smaller storage container 80 and the opposing frictional force between the door panels 112 and the sidewalls 82 of the smaller storage container 80. For the frictional control regime, the controller 127 and displacement sensor 128 form part of a closed-loop control system. In particular, the controller 127 calculates the downwards velocity and/or acceleration of the smaller storage container 80 every time the displacement sensor 128 measures the displacement of the smaller storage container 80 (which may be several times a second, depending on the sampling rate of the displacement sensor 128). The controller 127 then adjusts the angular position of the door panels 112 about their respective pivot axes 121 so as to keep the velocity and/or acceleration of the smaller storage container 80 under a predetermined maximum velocity and/or acceleration threshold. In particular, if the velocity and/or acceleration of the smaller storage container 80 at a particular point in time is greater than the predetermined maximum velocity and/or acceleration threshold, the controller 127 pivotally rotates the door panels 112 upwards to increase the frictional force between the door panels 112 and the smaller storage container 80 until the velocity and/or acceleration of the smaller storage container 80 falls below the maximum velocity and/or acceleration threshold. An example maximum descent acceleration threshold may be the acceleration due to gravity, approximately 9.8 m/s². The controller 127 may also pivotally rotate the doors panels downwards to decrease the frictional force and allow the velocity and/or acceleration of the smaller storage container 80 to increase if the velocity and/or acceleration of the smaller storage container 80 decreases below a predetermined minimum velocity and/or acceleration threshold.

At the transition point between the supported regime C1 and the frictional regime C2, the smaller storage container 80 may suddenly start to slip. The controller 127 may therefore determine the C1-C2 transition point by detecting when the velocity and/or acceleration of the smaller storage container 80 exceeds a predetermined transition velocity and/or acceleration threshold. Alternatively, a suitable C1-C2 transition point may be determined by trial and error experiments carried out before the automated container loader 100 is put into production.

After the smaller storage container 80 has reached the bottom of the larger storage container 90, the controller 127 during release control regime C3 pivotally rotates the door panels 112 downwards from their position at the end of the frictional control regime C2 to a substantially vertical position such that the door panels 112 are no longer in contact with the smaller storage container 80. The release control regime can be open-loop as there is no movement of the smaller storage container 80 and the door panels 112 just need to move to a predetermined angular position (the vertical position in this case).

The controller 127 can determine the transition point between the frictional regime C2 and the release regime C3 by detecting, via measurements from the displacement sensor, when the smaller storage container 80 has dropped by a known vertical distance corresponding to the vertical distance between the base of the smaller storage container 80 when on the closed trapdoor 111 and the base of the larger storage container 90 when in the loading position. Alternatively, if the weight of the smaller storage container 80 is known, then the C2-C3 transition point can be determined by including a weighing scale in the container support 130 and detecting when the weight of the larger storage container 90 has increased by the weight of the smaller storage container 80. Alternatively, sensors provided at or near the base of the larger storage container 90 may be used, though if the sensors are external to the larger storage container 90, this may require apertures to be provided through the sidewalls 92 of the larger storage container 90 so that the sensors can detect the presence of the smaller storage container 80 inside the larger storage container 90.

To reduce the cycle time of the loading operation, the time spent in each control regime can be optimised. For example, the time spent in the supported control regime can be made relatively short (by rotating the door panels 112 downwards relatively quickly) compared to the time spent in the frictional regime because there is no risk that the smaller storage container will be in free fall during the supported control regime. Similarly, the time spent in the release regime can also be made relatively short compared to the time spent in the frictional regime because the smaller storage container 80 is already fully loaded into the larger storage container 90 at the end of the frictional regime C2.

The above-described closed-loop frictional control regime is advantageous as it allows the container loading assembly 110 adapt to smaller storage containers 80 of different sizes and weights without prior knowledge of the size and weight of the smaller storage containers 80. Furthermore, the cycle time of the automated container load can be optimised to a greater degree compared to an open-loop control system. However, the controller 127 may alternatively use an open-loop control frictional control regime if the automated container loader 100 is designed to load smaller storage containers 80 of a particular size and/or weight (or within a particular size and/or weight range), or the automated container loader 100 is configured to determine the size and/or weight of the smaller storage container 80 before being received on the trapdoor 111. For example, the controller 127 may be configured to pivotally rotate the door panels 112 downwards from the horizontal position to the vertical position using a predetermined motion profile. The predetermined motion profile may be a single motion profile designed to be used with smaller storage containers 80 of a particular size and/or weight such that they do not exceed a predetermined maximum velocity and/or acceleration threshold during descent. Alternatively, the predetermined motion profile may be one of a plurality of predetermined motion profiles that is chosen depending on the size and/or weight of the smaller storage container 80. The predetermined motion profiles may have been created based on previous tests carried out with smaller storage containers 80 of different sizes and weights. The size and/or weight of the smaller storage container 80 may be determined before the smaller storage container 80 is received on the trapdoor 111 using, for example, appropriate sensors/machine vision and a weighing scale, or the size and weight of each smaller storage container 80 may be associated with a unique identifier on the smaller storage container 80 (e.g. a QR code or an RFID tag) that is read at the automated container loader 100 by an appropriate reader in communication with the controller 127.

Although FIGS. 8A-8E show the door panels 112 remaining rigid throughout the process, the door panels 112 may be flexible such that the free ends elastically deflect relative to the mounted ends under load from the smaller storage container 80, particularly during the frictional regime. This may result in increased contact area between the door panels 112 and the sidewalls 82 of the smaller storage container 80 during the frictional control regime, which may help to spread the wear on the door panels 112 over a larger area. The return force exerted on the smaller storage container 80 due to elastic deformation of the door panels 112 may also help to resist the gravitational force acting on the smaller storage container 80.

Given the high loads that may be experienced by the door panels 112 when engaged with the smaller storage container 80, and the frequent sliding contact between the door panels 112 and the smaller storage container 80 during use, the door panels 112 are preferably made from any suitable material with a high yield strength and wear resistance, such as a metal (e.g. stainless steel) or a composite material (e.g. carbon fibre).

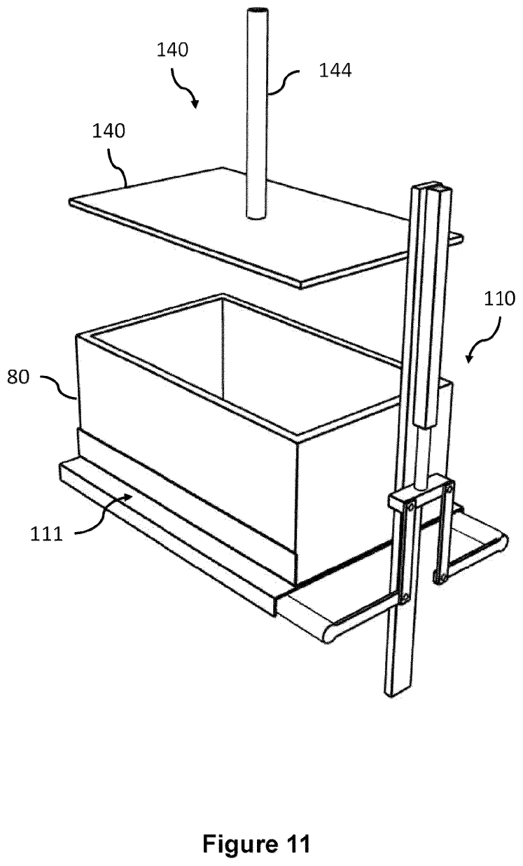

FIG. 11 shows an example of the container loading assembly 110 further comprising a pushing device 140 mounted above the trapdoor 111. The pushing device 140 comprises a horizontally orientated pushing plate 142 wide enough to engage with the top of the smaller storage container 80 and a linear actuator 144 for vertically moving the pushing plate 142 relative to the trapdoor 111. In this example, the smaller storage container 80 does not reach the bottom of the larger storage container 90 solely under the influence of gravity. Instead, the door panels 112 are downwardly rotated to an angular position such that the smaller storage container 80 is held substantially stationary by the door panels 112 at a position above the base of the larger storage container 90. The pushing device 140 then moves the pushing plate 142 downwards to push the smaller storage container 80 the rest of the way into the larger storage container 90 until it reaches the base of the larger storage container 90. The door panels 112 remain in the same angular position while the pushing device 140 operates such that the smaller storage container 80 is pushed past the door panels 112. This example is therefore particularly suited to door panels 112 that can elastically deflect under load, as already described above. The pushing device 140 can be configured to push down on the smaller storage container 80 at a predetermined rate such that the smaller storage container 80 does not exceed a predetermined maximum velocity and/or acceleration threshold in order to minimise the impact force between the smaller storage container 80 and the larger storage container 90 when they make contact.

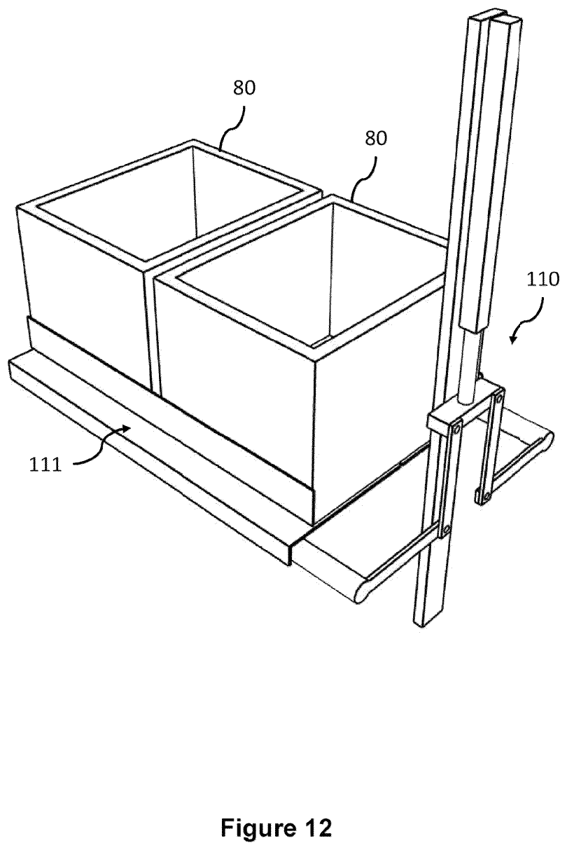

The automated container loader 100 may also be used to load a plurality of smaller storage containers 80 into a single larger storage container 90. As shown in FIG. 12, two smaller storage containers 80 may be received on the trapdoor 111 side-by-side such that they are each supported from below by both door panels 112. The smaller storage containers 80 shown in FIG. 12 are about half the size of the smaller storage container 80 shown in FIG. 1. In particular, the shortest horizontal edge of the smaller storage container 80 in FIG. 1 is approximately the same length of the longest horizontal edge of each of the smaller storage containers 80 of FIG. 12. In use, the smaller storage container 80 of FIG. 1 can be loaded onto the trapdoor 111 with the shortest horizontal edge leading and the smaller storage containers 80 of FIG. 12 can be loaded onto the trapdoor 111 with the longest horizontal edge leading. In this way, the same width conveyor can be used to feed both sizes of smaller storage container 80 onto the trapdoor 111. As the trapdoor 111 is opened, the plurality of smaller storage containers 80 descend into the larger storage container 90 in a similar manner as described above for a single smaller storage container 80.

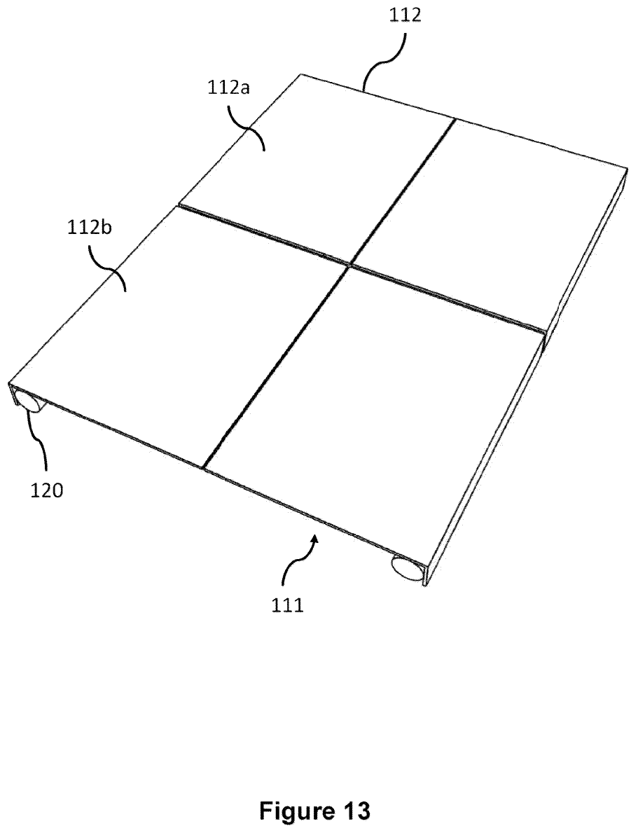

If one of the smaller storage containers 80 is smaller than the other in a direction perpendicular to the pivot axes 121, or if the smaller storage containers 80 have different weights, it may be beneficial to use elastically deflectable door panels 112 that are each split along an axis perpendicular to the pivot axes 121 such that each door panel 112 comprises two portions 112a, 112b as shown in FIG. 13. If more than two smaller storage containers 80 are to be loaded side-by-side, then the number of portions may be increased accordingly. The portions 112a, 112b of each door panel 112 are depicted as separate portions in FIG. 13, but they may also be joined at the mounted end of the door panel 112. Both portions of each door panel 112 are connected to the same shaft 120 so that both portions 112a, 112b pivotally rotate in unison but each portion 112a, 112b can deflect independently. In this example, the container loading assembly 110 comprises a displacement sensor 128 above each smaller storage container 80 for measuring the vertical displacement of each smaller storage container 80 during their descent and the controller 127 uses a closed-loop control system during the frictional control regime to control the angular position of the door panels 112 based on whichever smaller storage container 80 is descending or accelerating the fastest. In other words, the angular positon of the door panels 112 is controlled to keep the fastest descending smaller storage container 80 below a predetermined maximum velocity and/or acceleration threshold. In this way, it can be ensured that both of the smaller storage containers 80 will descend without going above the maximum velocity and/or acceleration threshold. Alternatively, each door panel portion 112a, 112b could be rigidly fixed to independently rotatable shafts 120 that so that the angular position of each door panel portion 112a, 112b can be individually controlled. Alternatively, the pusher device 140 described above can be used to push the smaller storage containers 80 down at the same particular rate in the manner described above in relation to FIG. 11.

As an alternative to loading a plurality of smaller storage containers 80 side-by-side into a single larger storage container 90, a plurality of smaller storage containers 80 may be loaded into a single larger storage container 90 such that they are vertically stacked within the larger storage container 90. To do this, a first smaller storage container 80 can be loaded into a larger storage container 90 in a first loading position in the manner already described above. The loaded larger storage container 90 can then be lowered so that the trapdoor 111 can be closed by rotating the door panels 112 back to the horizontal position. A second smaller storage container 80 can then be loaded into the larger storage container 90 in the same manner, but with the larger storage container 90 in a second loading position that is lower than the first loading position so that the door panels 112 do not hit the first smaller storage container 80 as they are pivotally rotated downwards.

The above two methods for loading a plurality of smaller storage containers 80 into a larger storage container 90 can also be combined such that the smaller storage containers are loaded in a side-by-side and vertically stacked arrangement, e.g. a 2×2 arrangement with two side-by-side smaller storage containers 80 in a first layer and another two side-by-side smaller storage containers 80 in a second layer above the first layer.

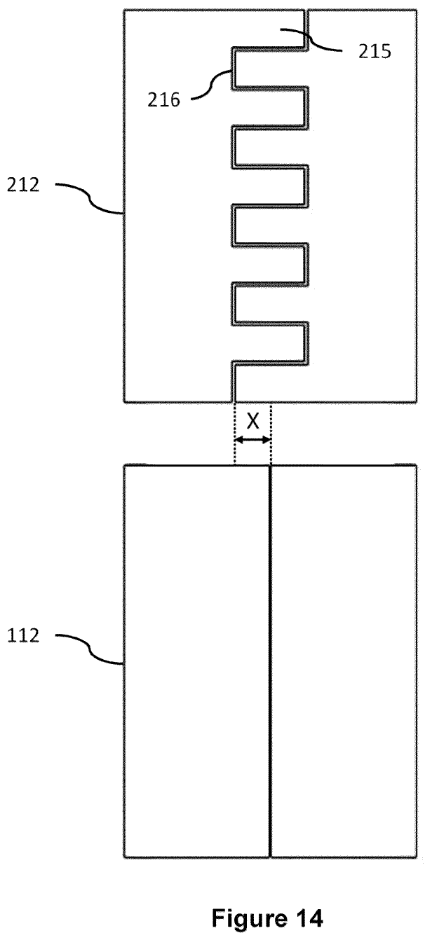

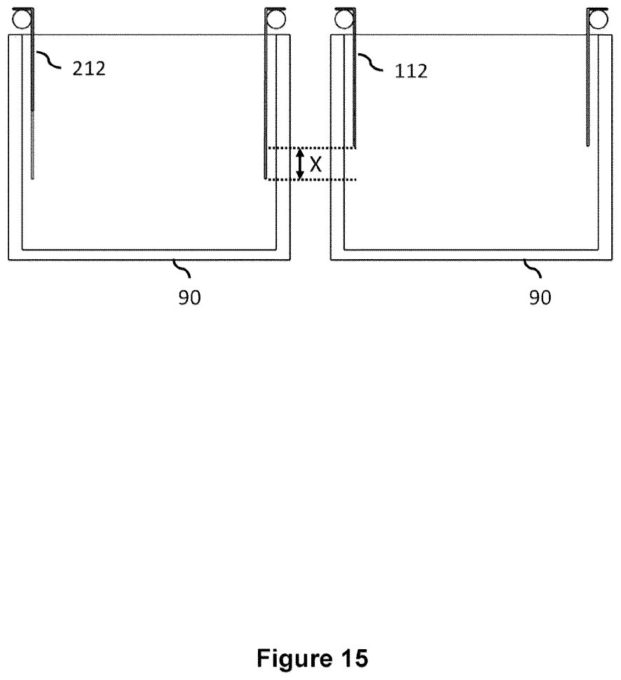

FIG. 14 shows a top view of alternative door panels 212 for use with the trapdoor 111 and a top view of the previous door panels 112 for comparison. In contrast to door panels 112 in which the free end 114 of each door panel 112 was straight, the free end 214 of each door panel 212 has a castellated shape, i.e. a series of alternating protrusions 215 and recesses 216 extending in the plane of the door panel 212. Furthermore, the castellations are arranged such that when the door panels 212 in the horizontal position, the castellations of one door panel 212 interdigitate the castellations of the other door panel 212, i.e. protrusions 215 of one of the door panels 212 fit in the recesses 216 of the other door panel 212 and vice versa. As illustrated by FIG. 14, this configuration effectively extends the maximum width of each door panel 212 past the midpoint between the two door panels 212 by a distance X in a way that doesn't cause the two door panels 212 to obstruct each other. This allows the door panels 212 to stay in contact with the smaller storage container 80 for a greater portion of the descent of the smaller storage container 80 compared to the door panels 112 of trapdoor 111 whose maximum widths are limited to being half the distance between the two pivot axes 121. This is illustrated by the side cross-sectional views shown in FIG. 15, in which the castellated door panels 212 shown on the left extended further into the larger storage container 90 by distance X compared to the door panels 112 shown on the right.

The above-described embodiments of the automated container loader 100 therefore use frictional engagement to load a smaller storage container 80 into a larger storage container 90 in an automated and controlled manner to avoid a large drop impact that could damage items (such as grocery items or fragile items) contained within the smaller storage container 80. However, the automated container loader 100 is not limited to loading a storage container into another storage container. In general, the automated container loader 100 may be used to drop other objects under gravity in a controlled manner to try and minimise damage to the object. For example, instead of loading a smaller storage container containing items into a larger storage container, the automated container loader 100 may be used to load items directly into a storage container or onto another surface.

The invention is not limited to the precise forms described above and various modifications and variations are possible without departing from the scope of the invention as defined in the accompanying claims. A non-exhaustive list of some example modifications and variations are described below.

Instead of the trapdoor 111 having two door panels 112, the trapdoor may comprise more than two door panels. For example, the trapdoor may comprise three, four, five, six or more door panels. The door panels and their respective pivot axes may be arranged symmetrically about a central point. The door panels may be triangular shaped and point inwards towards the central point.

Although FIGS. 1 and 3 show the smaller storage container 80 moving onto the trapdoor 111 in a direction parallel to the pivot axes 121 of the door panels 112, the smaller storage container 80 could also move onto the trapdoor in a direction perpendicular to the pivot axes 121. In this case, the side guides 119 may also be orientated in a direction perpendicular to the pivot axes 121. Similarly, the larger storage container 90 could move onto and off the container support 120 in a direction perpendicular to the pivot axes 121.

Instead of using an electric linear actuator 126 to drive rotation of the door panels 112, other actuators such as a pneumatic or hydraulic actuator may be used instead. Actuators that can only move between two extreme positions (without being able to stop at a position in between) can also be used in the automated container loader 100. In this case, an open-loop control system may be used in which the door panels 112 are pivotally rotated according to a predetermined motion profile such that the smaller storage container 80 does not exceed a predetermined maximum acceleration threshold. Such a system could be suitable for situations where smaller storage containers 80 of a predetermined size and weight (or within a predetermined size and weight range) are being loaded.

Instead of the door panels 112 being mechanically linked to a vertically guided carriage 123 by linkage arms 124 and joints 125, a different mechanism may be used to pivotally rotate the door panels 112 in unison. For example, rotation of the door panels 112 may be driven by a gear arrangement or a pulley arrangement. For example, a rack and pinion gear arrangement may be used where a common rack gear drives a pinion gear on each door panel 112.

Instead of the door panels 112 being configured to rotate in unison, the door panels 112 may be independently rotatable about their respective pivot axes 121, e.g. by using separately controlled rotary actuators for each door panel 112. In this case, the controller 127 may still be configured to rotate the door panels 112 in unison (by controlling the actuators in unison), or the controller 127 may adjust the angular position of one door panel 112 independently of the other door panel during the descent of the smaller storage container 80.

The control system may comprise a plurality of displacement sensors 128 configured to measure the vertical displacement of different portions of the smaller storage container 80 as the smaller storage container 80 descends into the larger storage container 90. For example, the displacement sensors 128 may be arranged to measure the vertical displacement of each corner of the smaller storage container 80. The controller 127 may calculate and use an average of the measurements from the plurality of displacement sensors 128. The controller 127 may also use the measurements from each displacement sensor 128 to detect when the smaller storage container 80 is tilting to one side with respect to a horizontal plane. In this case, if the door panels are configured to be independently rotatable, the controller 127 may be configured to adjust the angular position of each door panel to return the smaller storage container 80 to a substantially horizontal position. Alternatively, the controller 127 may be configured to halt further pivotal movement of the door panels so that the smaller storage container 80 can be manually removed from the trapdoor.

In the above-described release control regime C3, the door panels 112 are not limited to moving to the vertical position to disengage from the smaller storage container 80. The door panels 112 could disengage before the vertical position, or they could rotate past the vertical position to disengage, depending on the size of the smaller storage container 80. Furthermore, the release control regime can be omitted entirely from the control system because at the end of the frictional regime, the door panels 112 will still be at an angular position that allows the smaller storage container 80 to slide past them under gravity. Therefore, provided the larger storage container is lowered away from the trapdoor 111 at a slow enough rate, the smaller storage container 80 will descend with the larger storage container 90 until the smaller storage container 80 is vertically clear of the door panels 112. However, the release control regime C3 may be advantageous as it will reduce wear (cause by sliding contact) on the door panels 112 over time.

The controller 127 is not limited to controlling the door panels 112 in accordance with the above-described three control regimes C1-C3. Any number of control regimes may be used to provide the effect of reducing the impact force between the smaller storage container 80 and the larger storage container 90 when the smaller storage container 80 is loaded into the larger storage container 90. As already explained above, the release control regime C3 could be omitted. In another example, the frictional control regime in which the door panels are in contact with the sidewalls 82 of the smaller storage container 80 could be split into two control regimes—an open-loop control regime where the door panels are moved to a predetermined angular position using a predetermined motion profile, followed by closed-loop control regime where the angular position of the door panels 112 is adjusted based on feedback from the displacement sensor 128, as already described above. Splitting the frictional control regime C2 in this way may help to reduce the cycle time as the descent of the smaller storage container 80 does not necessarily need to be finely controlled during the beginning of the frictional control regime C2.

The door panels 112 do not necessarily need to stay in contact with the smaller storage container 80 throughout the whole descent of the smaller storage container 80 into the larger storage container 90. For example, if the door panels 112 are not wide enough, the frictional control regime may end (i.e. the door panels may disengage with the smaller storage container 80) before the smaller storage container 80 has reached the base of the larger storage container 90. This may be acceptable, provided that the free fall distance is short enough such that any items inside the smaller storage container 80 are not damaged when the smaller storage container 80 reaches the base of larger storage container 90.

Instead of the container support 130 comprising a lifting mechanism 134 for vertically moving the larger storage container 90 relative to the trapdoor 111 between the loading and release positions described above, the trapdoor 111 may comprise a lifting mechanism for vertically moving the trapdoor 111 relative to the larger storage container 90 to achieve the same effect, namely to vertically position the trapdoor 111 and the larger storage container 90 relative to each other in a loading configuration in which at least a portion of each door panel 112 enters the larger storage container as the door panels are pivotally rotated towards their final position, and in a release configuration in which the smaller storage container 80 is vertically clear of the door panels 112 when the door panels are in their final position.

The container loading assembly 110 does not necessarily need to be used to load smaller storage containers 80 in a downwards direction under gravity. In general, the door panels 112 of the trapdoor 111 can be pivotally rotated to an angular position in which they frictionally engage/resist movement of the smaller storage container 80 between the door panels 112 so as to control the velocity of the smaller storage container 80 as it passes between the door panels 112. The orientation of the trapdoor 111 can be changed to load a smaller storage container 80 into a larger storage container 90 in any particular direction, e.g. in a horizontal direction or an upwards direction. Such examples would need to be used with a pushing device, such as the pushing device 140 described above, to push the smaller storage container 80 in the desired direction through the trapdoor 111.

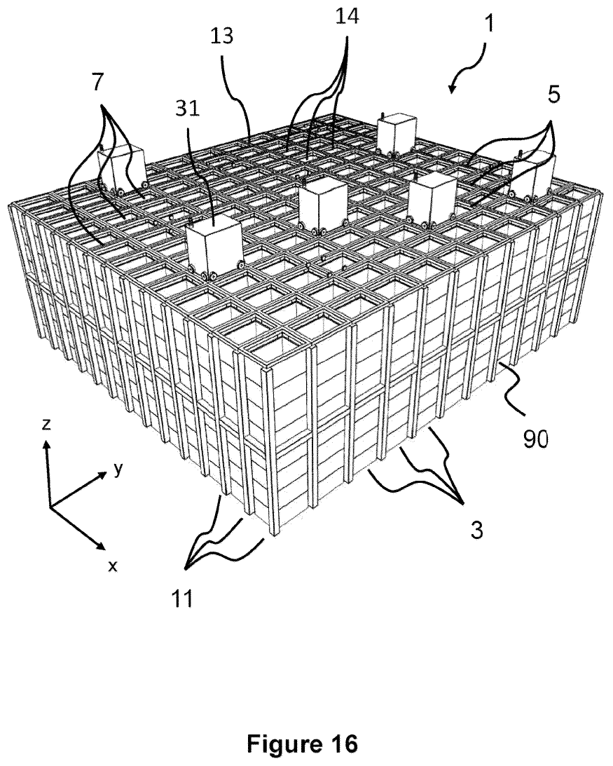

The automated container loader 100 may be part of a storage and retrieval system in which stacks of larger storage containers 90 are arranged within a 3D grid storage structure. An example grid storage structure 1 is shown in FIG. 16. The grid storage structure 1 comprises upright members 3 which support a first and second set of horizontal members 5, 7. The first and second set of horizontal members 5, 7 extend perpendicular to each other to form a grid pattern defining a plurality of grid cells 14. The larger storage containers 90 are arranged in stacks 11 beneath the grid cells 14, with one stack of larger storage containers per grid cell. The larger storage containers 90 are accessed from above by load handling devices 31 operative on a track structure 13 located at the top of the grid storage structure. The track structure 13 may comprise tracks mounted on top of the horizontal member 5, 7, or the tracks may be provided by the horizontal members 5, 7 themselves (e.g. formed in or on the surfaces of the horizontal members 5, 7). The automated container loader 100 may be located at an inbound area of the storage and retrieval system in which smaller storage containers 80 containing items (e.g. grocery items) are received and loaded into empty larger storage containers 90 using the automated container loader 100. The loaded larger storage containers may then transported to the grid storage structure 1 for storage in a stack 11 within the grid storage structure 1.

1-20- (canceled)

21. An automated container loader for loading a smaller storage container into a larger storage container, the automated container loader comprising:
a container support configured for receiving a larger storage container; and
a container loading assembly configured to receive a smaller storage container above a larger storage container and release the smaller storage container to allow the smaller storage container to descend under gravity into the larger storage container;
wherein the container loading assembly includes a plurality of engagement surfaces configured to engage the smaller storage container during at least a portion of a descent of the smaller storage container to control a descent velocity of the smaller storage container under gravity.

22. The automated container loader of claim 21, wherein the container loading assembly comprises:
a trapdoor including at least two door panels, each door panel defining one of the plurality of engagement surfaces and each door panel being pivotally mounted for rotation about a respective horizontal pivot axis, wherein the door panels are pivotally rotatable downwards from a substantially horizontal initial position for receiving the smaller storage container above the larger storage container, towards a final position to allow the smaller storage container to descend between the pivot axes into the larger storage container under gravity; and
a control system including a controller configured to control pivotal rotation of the door panels between the initial position and the final position such that the door panels will frictionally engage the smaller storage container during at least a portion of the descent of the smaller storage container to control the descent velocity of the smaller storage container under gravity.

23. The automated container loader of claim 22, wherein the controller is configured to control pivotal rotation of the door panels such that the door panels will frictionally engage respective sidewalls of the smaller storage container during at least a portion of the descent of the smaller storage container wherein the door panels are stoppable at least one intermediate angular position between the initial position and the final position.

24. The automated container loader of claim 22, wherein the control system comprises:
at least one displacement sensor configured to measure a vertical displacement of the smaller storage container during said portion of the descent of the smaller storage container, and the controller is configured to control an angular position of the door panels based on displacement measurements from the at least one displacement sensor.

25. The automated container loader of claim 24, wherein the controller is configured to determine the descent velocity and/or acceleration of the smaller storage container based on measurements from the at least one displacement sensor, and the controller is configured to control the angular position of the door panels to keep the descent velocity and/or acceleration of the smaller storage container below a maximum velocity and/or acceleration threshold, wherein the controller is configured to pivotally rotate the door panels upwards when the descent velocity and/or acceleration of the smaller storage container exceeds the maximum velocity and/or acceleration threshold, wherein the controller is configured to pivotally rotate the door panels downwards when the descent velocity and/or acceleration of the smaller storage container falls below a minimum velocity and/or acceleration threshold.

26. The automated container loader of claim 22, wherein: the control system comprises:
a plurality of displacement sensors configured to measure vertical displacement of different portions of the smaller storage container during descent of the smaller storage container; the controller is configured to determine an orientation of the smaller storage container relative to a horizontal plane based on the measurements from the plurality of displacement sensors; and the controller is configured to halt pivotal rotation of the door panels when the controller determines that the smaller storage container has titled away from the horizontal plane by a predetermined extent, and wherein the control system comprises:
a plurality of displacement sensors configured to measure the vertical displacement of different portions of the smaller storage container during descent of the smaller storage container;
the controller is configured to determine an orientation of the smaller storage container relative to a horizontal plane based on the measurements from the plurality of displacement sensors; and
the controller is configured to control the angular position of each door panel to keep the orientation of the smaller storage container substantially horizontal during the descent of the smaller storage container.

27. The automated container loader of claim 22, wherein the controller is configured to pivotally rotate the door panels between the initial position and the final position according to a predetermined motion profile.

28. The automated container loader of claim 22, wherein the controller is configured to control pivotal rotation of the door panels to stop the descent of the smaller storage container at an intermediate descent position above a final descent position, and the container loading assembly comprises:
a pushing device configured to push the smaller storage container downwards from the intermediate descent position to the final descent position at a predetermined rate.

29. The automated container loader of claim 22, wherein the door panels are elastically deflectable, wherein each door panel is split along a direction perpendicular to the pivot axis to define a first door panel portion and a second door panel portion.

30. The automated container loader of claim 22, wherein each door panel comprises:
a mounted end at which the door panel is pivotally mounted, and a free end opposing the mounted end, wherein each free end has a castellated shape and the door panels are configured and arranged such that the castellations of the free ends interdigitate when the door panels are in the horizontal initial position.

31. The automated container loader of claim 22, wherein the door panels are configured to pivotally rotate in unison.

32. The automated container loader of claim 22, wherein the door panels are pivotally rotatable independently of each other and the controller is configured to control the angular position of the door panels independently of each other.

33. The automated container loader of claim 22, wherein the container loading assembly comprises:
guide members above the trapdoor, the guide members being configured to engage respective sidewalls of the smaller storage container to guide the smaller storage container to a symmetrical position on the door panels and/or to help maintain the smaller storage container in a vertical orientation during at least a portion of the descent of the smaller storage container into the larger storage container.

34. The automated container loader of claim 22, wherein the container support and the trapdoor are vertically moveable relative to each other to allow the larger storage container and the door panels to be moved into a relative position in which pivotal rotation of the door panels from the initial position to the final position will cause the door panels to rotate into the larger storage container.

35. A method for loading a smaller storage container into a larger storage container in an automated manner, the method comprising:
receiving a smaller storage container on a trapdoor above a larger storage container, the trapdoor including at least two pivotally mounted door panels in a horizontal initial position for receiving the smaller storage container;
pivotally rotating the door panels downwards to allow the smaller storage to descend between the door panels into the larger storage container under gravity; and
controlling pivotal rotation of the door panels during a descent of the smaller storage container such that the door panels will frictionally engage the smaller storage container during at least a portion of the descent.
